(19) United States
(12) Patent Application Publication
(10) Pub. No.: US 2019/0063583 A1
(43) Pub. Date: Feb. 28, 2019

(54) VEHICLE IN-WHEEL TYPE MOTOR DRIVE DEVICE

(71) Applicant: TOYOTA JIDOSHA KABUSHIKI KAISHA, Toyota-shi (JP)

(72) Inventor: Kenji ODAKA, Toyota-shi (JP)

(73) Assignee: TOYOTA JIDOSHA KABUSHIKI KAISHA, Toyota-shi (JP)

(21) Appl. No.: 16/104,183

(22) Filed: Aug. 17, 2018

(30) Foreign Application Priority Data
Aug. 29, 2017 (JP) 2017-164872

(51) Int. Cl. F16H 57/00; B60K 7/00; B60K 17/04; F16H 1/06; F16H 57/028

(52) U.S. Cl. CPC F16H 57/0006; B60K 7/0007; B60K 17/043; F16H 2057/02034; F16H 57/028; B60K 2007/0061; B60K 2007/0038; F16H 1/06

(57) ABSTRACT

A vehicle in-wheel type motor drive device comprises: a motor portion including an electric motor; and a reducer portion that is fixed to a non-rotating member rotatably supporting a wheel and that includes a reducer reducing a speed of rotation input from a motor rotating shaft of the electric motor to output the rotation from an output shaft concentric with the wheel, the vehicle in-wheel type motor drive device rotationally driving the wheel by the output of the reducer portion. An end portion of the motor rotating shaft on the reducer portion side is rotatably supported in a cantilever manner by the reducer portion, and a coupling device coupling the motor portion via an elastic member to the reducer portion is disposed between the motor portion and the reducer portion.

This application claims priority from Japanese Patent Application No. 2017-164872 filed on Aug. 29, 2017, the disclosure of which is herein incorporated by reference in its entirety.

### TECHNICAL FIELD

The present invention relates to a vehicle in-wheel type motor drive device for driving a wheel of a vehicle.

### BACKGROUND ART

A vehicle in-wheel type motor drive device is known that comprises an electric motor housed in a motor-portion case, and a reducer (speed reducer) housed in a reducer-portion case to which the motor-portion case is fixed and reducing a speed of rotation input from the electric motor to transmit the rotation to a shaft portion of a wheel hub to which a wheel is attached and that is in a form in which the motor-portion case is coupled to a non-rotating suspension member via an elastic member to allow the non-rotating suspension member to receive through the motor-portion case and the elastic member a reaction force of a drive force transmitted from the electric motor to the wheel. For example, this corresponds to a vehicle in-wheel type motor drive device described in Patent Document 1.

### PRIOR ART DOCUMENT

### Patent Document

Patent Document 1: Japanese Laid-Open Patent Publication No. 2016-222164

### SUMMARY OF THE INVENTION

### Technical Problem

In the vehicle in-wheel type motor drive device as described above, a rotation center line of a shaft portion of a wheel hub concentric with a wheel is offset from a motor rotation shaft of an electric motor, i.e., a rotation center line of an input gear of a reducer, and the gravity center of the electric motor having a relatively large mass is on the rotation center line of the input gear of the reducer and is therefore located at a position deviated from the rotation center line of the shaft portion of the wheel hub concentric with the wheel, i.e., at an eccentric position.

Therefore, when a change in drive force from the electric motor causes the non-rotating suspension member to receive the reaction force of the drive force through the motor-portion case and the elastic member, the gravity center of the electric motor swings around the rotation center line of the wheel within a range of deformation of the elastic member, and therefore, vibration occurs in the vertical direction of the vehicle or the longitudinal direction of the vehicle, so that the vibration is transmitted via the suspension to a vehicle body, causing a problem of reduced ride quality. When the wheel is moved up and down during running on a rough road etc. and vibration thereof is transmitted to the in-wheel type motor drive device, since the gravity center of the electric motor having a relatively large mass as described above is at an eccentric position deviated from the rotation center line of the shaft portion of the wheel hub concentric with the wheel, the gravity center of the electric motor moves up and down in an amplified manner as compared to the up-and-down motion of the in-wheel type motor drive device, causing problems of deteriorated ride quality of the vehicle and impaired durability of a hub bearing.

The present invention was conceived in view of the situations and it is therefore an object of the present invention to provide a vehicle in-wheel type motor drive device suppressing the occurrence of vehicle body vibration caused by eccentricity of the gravity center of the electric motor and suppressing the deterioration in ride quality of a vehicle.

### Solution to Problem

To achieve the above object, a first aspect of the present invention provides a vehicle in-wheel type motor drive device comprising: a motor portion including an electric motor; and a reducer portion that is fixed to a non-rotating member rotatably supporting a wheel and that includes a reducer reducing a speed of rotation input from a motor rotating shaft of the electric motor to output the rotation from an output shaft concentric with the wheel, the vehicle in-wheel type motor drive device rotationally driving the wheel by the output of the reducer portion, wherein an end portion of the motor rotating shaft on the reducer portion side is rotatably supported in a cantilever manner by the reducer portion, and wherein a coupling device coupling the motor portion via an elastic member to the reducer portion is disposed between the motor portion and the reducer portion.

A second aspect of the present invention provides the vehicle in-wheel type motor drive device recited in the first aspect of the invention, wherein the reducer portion includes a reducer case housing the reducer and fixed to the non-rotating member, wherein the motor portion includes a motor case housing the electric motor in a state of being separated from the reducer case, and wherein the coupling device is disposed between the motor case and the reducer case.

A third aspect of the present invention provides the vehicle in-wheel type motor drive device recited in the first or second aspect of the invention, wherein the coupling device is disposed at a plurality of positions around the motor rotation axis.

A fourth aspect of the present invention provides the vehicle in-wheel type motor drive device recited in the third aspect of the invention, wherein the coupling devices disposed at the plurality of positions include respective elastic members, and the elastic members are disposed to symmetrically act about a rotation center line or a gravity center of the electric motor.

A fifth aspect of the present invention provides the vehicle in-wheel type motor drive device recited in any one of the first to fourth aspects of the invention, wherein the coupling device absorbs a swing of the motor portion with respect to the reducer portion and limits a relative rotation of the motor portion to the reducer portion around the motor rotating shaft.

A sixth aspect of the present invention provides the vehicle in-wheel type motor drive device recited in any one of the first to fifth aspects of the invention, wherein the motor portion is supported by the reducer portion via the motor rotating shaft.

A seventh aspect of the present invention provides the vehicle in-wheel type motor drive device recited in any one of the first to sixth aspects of the invention, wherein the reducer is a two axes gear reducer in which a small-diameter reduction gear disposed on the motor rotating shaft serving as an input shaft and a large-diameter reduction gear disposed on the output shaft are meshed with each other.

An eighth aspect of the present invention provides the vehicle in-wheel type motor drive device recited in any one of the first to seventh aspects of the invention, wherein a hub-side end portion of the output shaft is rotatably supported via a hub bearing by the non-rotating member, and wherein the wheel is detachably attached to a hub flange fixed to a tip of the output shaft.

### Advantageous Effects of Invention

The vehicle in-wheel type motor drive device recited in the first aspect of the invention comprises the motor portion including the electric motor, and the reducer portion that is fixed to the non-rotating member rotatably supporting the wheel and that includes the reducer reducing a speed of rotation input from the motor rotating shaft of the electric motor to output the rotation from the output shaft concentric with the wheel, and rotationally drives the wheel by the output of the reducer portion. The end portion of the motor rotating shaft on the reducer portion side is rotatably supported in a cantilever manner by the reducer portion, and the coupling devices coupling the motor portion via the elastic members to the reducer portion is disposed between the motor portion and the reducer portion. Therefore, even if a change occurs in the drive force of the electric motor or the vehicle in-wheel type motor drive device vibrates up and down, the motor portion is coupled to the reducer portion by the coupling devices via the elastic members so that the change in the drive force of the electric motor and the vibration associated with the up-and-down motion of the vehicle in-wheel type motor drive device are absorbed, and therefore, the occurrence of vehicle body vibration and the deterioration in the ride quality of the vehicle due to the eccentricity of the gravity center of the electric motor are suppressed.

According to the vehicle in-wheel type motor drive device recited in the second aspect of the invention, the reducer portion includes the reducer case housing the reducer and fixed to the non-rotating member, and the motor portion includes the motor case housing the electric motor in a state of being separated from the reducer case, while the coupling device is disposed between the motor case and the reducer case. Since the motor case and the reducer case separated from each other are coupled via the elastic members by the coupling devices in this way, even if a change occurs in the drive force of the electric motor or the vehicle in-wheel type motor drive device vibrates up and down, the change in the drive force of the electric motor and the vibration associated with the up-and-down motion of the vehicle in-wheel type motor drive device are absorbed by the elastic members of the coupling devices, so that the occurrence of vehicle body vibration and the deterioration in the ride quality of the vehicle due to the eccentricity of the gravity center of the electric motor are suppressed.

According to the vehicle in-wheel type motor drive device recited in the third aspect of the invention, the coupling device is disposed at multiple positions around the motor rotating shaft. As a result, the change in the drive force of the electric motor and the vibration associated with the up-and-down motion of the vehicle in-wheel type motor drive device are absorbed by the elastic member of the coupling device disposed at multiple positions, so that the occurrence of vehicle body vibration and the deterioration in the ride quality of the vehicle due to the eccentricity of the gravity center of the electric motor are suppressed.

According to the vehicle in-wheel type motor drive device recited in the fourth aspect of the invention, the respective elastic members of the coupling devices disposed at multiple positions are disposed to symmetrically act about the rotation center line or the gravity center of the electric motor. As a result, the change in the drive force of the electric motor and the vibration associated with the up-and-down motion of the vehicle in-wheel type motor drive device are effectively absorbed by the elastic member of the coupling device disposed at multiple positions.

According to the vehicle in-wheel type motor drive device recited in the fifth aspect of the invention, the coupling device absorbs the swing of the motor portion with respect to the reducer portion and limits the relative rotation of the motor portion to the reducer portion around the motor rotating shaft. As a result, the relative rotation of the motor portion to the reducer portion around the motor rotating shaft due to the change in the drive force of the electric motor and the swing of the motor portion with respect to the reducer portion due to vibration associated with the up-and-down motion of the vehicle in-wheel type motor drive device are suitably absorbed by the elastic member of the coupling device.

According to the vehicle in-wheel type motor drive device recited in the sixth aspect of the invention, the motor portion is supported by the reducer portion via the motor rotating shaft. As a result, the motor portion is supported without fixing the motor case of the motor portion to the reducer case of the reducer portion.

According to the vehicle in-wheel type motor drive device recited in the seventh aspect of the invention, the reducer is a two axes gear reducer in which the small-diameter reduction gear disposed on the motor rotating shaft functioning as an input shaft and the large-diameter reduction gear disposed on the output shaft are meshed with each other. As a result, the compactly-configured vehicle in-wheel type motor drive device is obtained.

According to the vehicle in-wheel type motor drive device recited in the eighth aspect of the invention, the hub-side end portion of the output shaft is rotatably supported via the hub bearing by the non-rotating member, and the wheel is detachably attached to the hub flange fixed to the tip of the output shaft. As a result, the wheel is rotationally driven by the electric motor.

### BRIEF DESCRIPTION OF DRAWINGS

FIG. 1 is a cross-sectional view of a structure of an in-wheel type motor drive device for a vehicle according to an example of the present invention.

FIG. 2 is a side view of the vehicle in-wheel type motor drive device of FIG. 1 as viewed from a center of a vehicle.

FIG. 3 is a schematic cross-sectional view of a structure of a vehicle in-wheel type motor drive device according to another example of the present invention, corresponding to FIG. 1.

FIG. 4 is a schematic cross-sectional view of a structure of a vehicle in-wheel type motor drive device according to still another example of the present invention, corresponding to FIG. 1.

### MODES FOR CARRYING OUT THE INVENTION

An example of a vehicle in-wheel type motor drive device of the present invention will now be described in detail with reference to the drawings.

### EXAMPLE 1

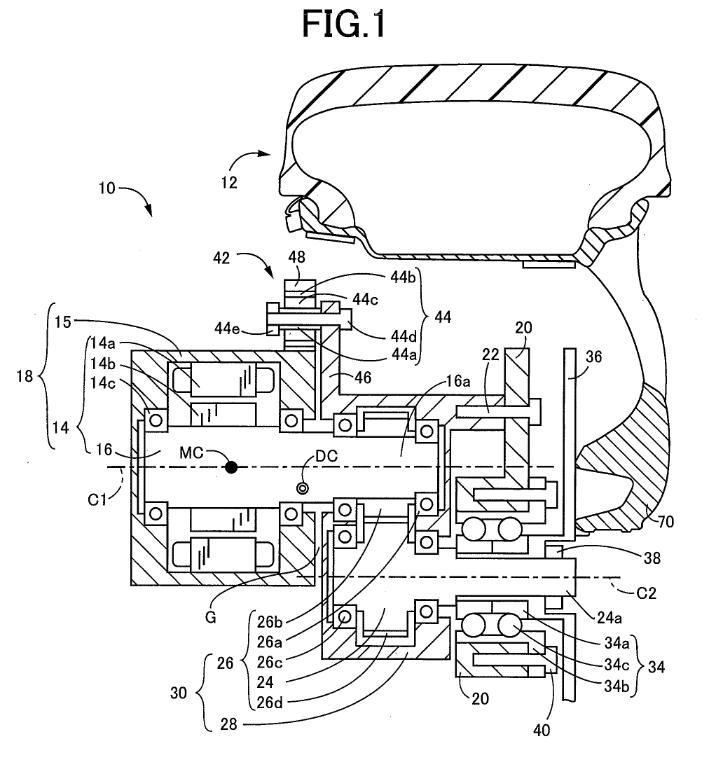

FIG. 1 is a cross-sectional view of a structure of an in-wheel type motor drive device 10 for a vehicle according to an example of the present invention. The in-wheel type motor drive device 10 is disposed inside a wheel 12 of an EV vehicle (electric vehicle), an FC vehicle (fuel-cell vehicle), an HV vehicle (hybrid vehicle), etc. The wheel 12 is not shown on the lower side from a second rotation center line C2 that is the rotation center thereof.

The in-wheel type motor drive device 10 includes a motor portion 18 including an electric motor 14 and a reducer portion 30 including a reducer (speed reducer) 26. The motor portion 18 is a motor unit having the electric motor 14 and a cylindrical motor case 15 housing the electric motor 14. The reducer portion 30 is a reducer unit having the reducer 26 reducing a speed of rotation input from a motor rotating shaft 16 of the electric motor 14 and outputting the rotation from an output shaft 24 concentric with the wheel 12, and a reducer case 28 fastened by a fastening bolt 22 to a wheel hub 20 that is a non-rotating member rotatably supporting the wheel 12 to house the reducer 26. The wheel 12 is rotationally driven by the output from the reducer portion 30. The wheel hub 20 is called a hub or a hub knuckle, for example, and is a non-rotating member coupled via a suspension not shown to a vehicle body not shown. The motor case 15 is separated from the reducer case 28.

The electric motor 14 housed in the motor case 15 is made up of a cylindrical stator 14a fixedly disposed on an inner circumferential surface of the motor case 15, and a rotor 14b fixed with the motor rotating shaft 16 concentrically rotatably disposed through the inside of the stator 14a. The motor rotating shaft 16 is rotatably supported by the motor case 15 via a motor bearing 14c. The electric motor 14 is preferably a motor generator functioning as an electric motor and an electric generator, for example, a three-phase AC synchronous electric motor.

The reducer 26 housed in the reducer case 28 is rotatably supported via an input-side bearing 26a by the reducer case 28 and includes a reducer-side end portion 16a of the motor rotating shaft 16, a small-diameter reduction gear 26b fixed to the reducer-side end portion 16a of the motor rotating shaft 16, the output shaft 24 rotatably supported by the reducer case 28 via an output-side bearing 26c in the reducer case 28 and disposed concentrically with the wheel 12 and parallel with the motor rotating shaft 16, and a large-diameter reduction gear 26d fixed to the output shaft 24 and meshed with the small-diameter reduction gear 26b. The reducer-side end portion 16a of the motor rotating shaft 16 is a portion of the motor rotating shaft 16 projecting from the motor case 15 and functions as an input shaft of the reducer 26. The small-diameter reduction gear 26b and the large-diameter reduction gear 26d meshed therewith are preferably helical gears.

Since a first rotation center line C1 serving as a rotation axis of the electric motor 14 and the motor rotating shaft 16 is parallel with the second rotation center line C2 serving as the rotation axis of the wheel 12 and the output shaft 24, the reducer 26 constitutes a parallel two axes gear reducer. FIG. 1 is a cross-sectional view of a section passing through the first rotation center line C1 and the second rotation center line C2. As shown in FIG. 1, a gravity center MC of the electric motor 14, i.e., the motor portion 18, is located on the first rotation center line Cl. A gravity center DC of the in-wheel type motor drive device 10 is located at a position between the first rotation center line C1 and the second rotation center line C2 and between the gravity center MC of the motor portion 18 and the wheel hub 20, and the gravity center MC of the motor portion 18 is decentered upward and on the side opposite to the wheel hub 20 from the gravity center DC of the in-wheel type motor drive device 10.

A hub-side end portion 24a of the output shaft 24 projecting from the reducer case 28 functions as an axle and is rotatably supported by the wheel hub 20 via a hub bearing 34. A flange-like hub flange 36 having the wheel 12 detachably fixed thereto by a nut not shown is fastened to the hub-side end portion 24a of the output shaft 24 by a nut 38. The hub bearing 34 includes an inner ring 34a and an outer ring 34b as well as multiple spherical rolling elements 34c arranged therebetween in two rows in a circumferential direction, and the outer ring 34b is fastened to the hub flange 36 by a bolt 40.

The reducer-side end portion 16a of the motor rotating shaft 16 is rotatably supported in a cantilever manner via the input-side bearing 26a by the reducer case 28 fixedly disposed on the wheel hub 20. The motor case 15 is separated from the reducer case 28 by a predetermined gap G As a result, the motor portion 18 is supported by the reducer case 28 via the motor rotating shaft 16.

A coupling device 42 elastically coupling the motor portion 18 and the reducer portion 30 via an elastic device 44 is disposed at multiple positions, or three positions in this example, between the reducer case 28 and the motor case 15 separated from the reducer case 28. As a result, the elastic device 44 disposed in the coupling device 42 absorbs a relative rotation of the motor portion 18 to the reducer portion 30 around the motor rotating shaft 16 or the first rotation center line C1 due to a change in drive force of the electric motor 14 and a swing of the motor portion 18 with respect to the reducer portion 30 due to vibration associated with an up-and-down motion of the vehicle in-wheel type motor drive device 10, and at the same time, the relative rotation of the motor portion 18 to the reducer portion 30 around the motor rotating shaft 16 is restricted (prevented).

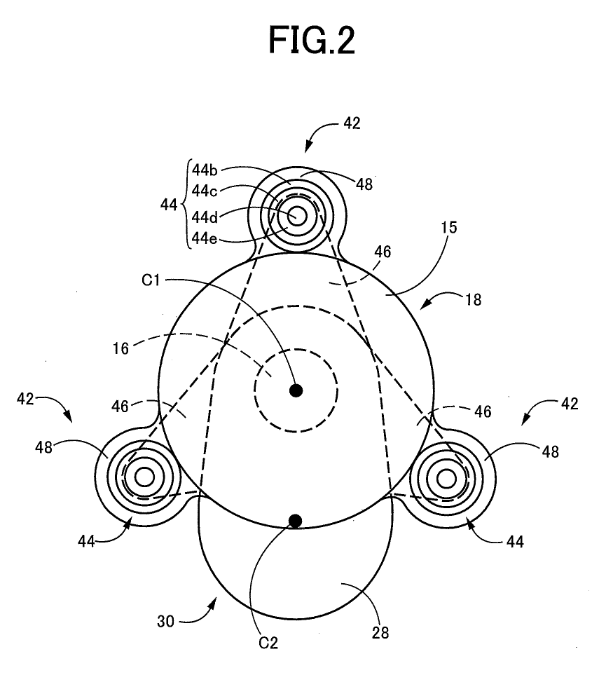

As also shown in FIG. 2, the coupling device 42 includes three brackets 46 disposed in a projecting manner from an end portion of the reducer case 28 on the motor case 15 side toward the outer circumferential side from the first rotation center line C1 at equal angular intervals around the first rotation center line C1, three holding cylinders 48 fixedly attached by welding etc. to an end portion of an outer circumferential surface of the motor case 15 on the reducer case 28 side and disposed at equal angular intervals around the first rotation center line C1, and the elastic devices 44 respectively interposed between tip portions of the brackets 46 and the holding cylinders 48.

The elastic devices 44 each include a small-diameter cylindrical body 44a and a large-diameter cylindrical body 44b arranged concentrically, a cylindrical elastic member 44c located between the small-diameter cylindrical body 44a and the large-diameter cylindrical body 44b and bonded to an outer circumferential surface of the small-diameter cylindrical body 44a and an inner circumferential surface of the large-diameter cylindrical body 44b by vulcanization, for example, and a fastening bolt 44d penetrating the small-diameter cylindrical body 44a and a nut 44e screwed thereto, and the large-diameter cylindrical body 44b is press fitted into the holding cylinder 48, while the fastening bolt 44d is fastened by the nut 44e through a tip portion of the bracket 46 in a posture parallel to the first rotation center line C1, so that the motor portion 18 and the reducer portion 30 are elastically coupled.

The elastic member 44c is made of synthetic rubber, for example, and may have a hollow structure in which a space is partially formed in the elastic member 44c, a liquid-containing structure with a liquid-filled chamber in the elastic member 44c, etc. for enhancing a vibration absorbing performance and damping characteristics.

In this example, the respective elastic devices 44 of the coupling devices 42 disposed at the three positions around the first rotation center line C1 are disposed at equal angular intervals around the first rotation center line C1 to perform a symmetrical and uniform elastic action about the first rotation center line C1 of the electric motor 14. In the cross-sectional view of FIG. 1, the elastic device 44 of the coupling device 42 is shown at one position above the first rotation center line C1; however, in the side view of FIG. 2 in which an up-down direction indicates the vertical direction, the elastic devices 44 are shown at equal angular interval positions, i.e., at intervals of 120°, around the first rotation center line C1.

Regarding the relative rotation of the motor portion 18 to the reducer portion 30 around the motor rotating shaft 16 or the first rotation center line C1 due to a change in the drive force of the electric motor 14 and the swing of the motor portion 18 with respect to the reducer portion 30 due to vibration associated with an up-and-down motion of the vehicle in-wheel type motor drive device 10, the symmetrical and uniform vibration suppressing action can be obtained at any positions around the first rotation center line C1.

According to the in-wheel type motor drive device 10 of this example configured as described above, the reducer-side end portion 16a of the motor rotating shaft 16 is rotatably supported in a cantilever manner by the reducer portion 30, and the coupling devices 42 coupling the motor portion 18 via the elastic members 44c to the reducer portion 30 is disposed between the motor portion 18 and the reducer portion 30. Therefore, even if a change occurs in the drive force of the electric motor 14 or the vehicle in-wheel type motor drive device 10 vibrates up and down, the motor portion 18 is coupled to the reducer portion 30 by the coupling devices 42 via the elastic members 44c so that the change in the drive force of the electric motor 14 and the vibration associated with the up-and-down motion of the vehicle in-wheel type motor drive device 10 are absorbed, and therefore, the occurrence of vehicle body vibration and the deterioration in the ride quality of the vehicle due to the eccentricity of the gravity center MC of the electric motor 14 are suppressed.

According to the vehicle in-wheel type motor drive device 10 of this example, the reducer portion 30 has the reducer case 28 housing the reducer 26 and fixed to the wheel hub 20 that is a non-rotating member, and the motor portion 18 has the motor case 15 housing the electric motor 14 in a state of being separated from the reducer case 28, while the coupling device 42 is disposed between the motor case 15 and the reducer case 28. Since the motor case 15 and the reducer case 28 separated from each other are coupled via the elastic members 44c by the coupling devices 42 in this way, even if a change occurs in the drive force of the electric motor 14 or the vehicle in-wheel type motor drive device 10 vibrates up and down, the change in the drive force of the electric motor 14 and the vibration associated with the up-and-down motion of the vehicle in-wheel type motor drive device 10 are absorbed by the elastic members 44c of the coupling devices 42, so that the occurrence of vehicle body vibration and the deterioration in the ride quality of the vehicle due to the eccentricity of the gravity center MC of the electric motor 14 are suppressed.

According to the vehicle in-wheel type motor drive device 10 of this example, the coupling device 42 is disposed at multiple positions around the motor rotating shaft 16. As a result, the change in the drive force of the electric motor 14 and the vibration associated with the up-and-down motion of the vehicle in-wheel type motor drive device 10 are absorbed by the elastic member 44c of the coupling device 42 disposed at multiple positions, so that the occurrence of vehicle body vibration and the deterioration in the ride quality of the vehicle due to the eccentricity of the gravity center MC of the electric motor 14 are suppressed.

According to the vehicle in-wheel type motor drive device 10 of this example, the elastic member 44c of the coupling device 42 disposed at multiple positions is disposed to symmetrically act about the first rotation center line C1. As a result, the change in the drive force of the electric motor 14 and the vibration associated with the up-and-down motion of the vehicle in-wheel type motor drive device 10 are effectively absorbed by the elastic member 44c of the coupling device 42 disposed at multiple positions.

According to the vehicle in-wheel type motor drive device 10 of this example, the coupling device 42 absorbs the swing of the motor portion 18 with respect to the reducer portion 30 while limiting the relative rotation of the motor portion 18 to the reducer portion 30 around the motor rotating shaft 16. As a result, the relative rotation of the motor portion 18 to the reducer portion 30 around the motor rotating shaft 16 due to the change in the drive force of the electric motor 14 and the swing of the motor portion 18 with respect to the reducer portion 30 due to vibration associated with the up-and-down motion of the vehicle in-wheel type motor drive device 10 are suitably absorbed by the elastic member 44c of the coupling device 42.

According to the vehicle in-wheel type motor drive device 10 of this example, the motor portion 18 is supported by the reducer portion 30 via the motor rotating shaft 16. As a result, the motor portion 18 is supported without fixing the motor case 15 of the motor portion 18 to the reducer case 28 of the reducer portion 30.

According to the vehicle in-wheel type motor drive device 10 of this example, the reducer 26 is a two axes gear reducer in which the reducer-side end portion 16a of the motor rotating shaft 16 functioning as an input shaft, the small-diameter reduction gear 26b disposed on the reducer-side end portion 16a, and the large-diameter reduction gear 26d disposed on the output shaft 24 are meshed with each other. As a result, the compactly-configured vehicle in-wheel type motor drive device 10 is obtained.

According to the vehicle in-wheel type motor drive device 10 of this example, the hub-side end portion 24a of the output shaft 24 is rotatably supported via the hub bearing 34 by the wheel hub 20 that is a non-rotating member, and the wheel 12 is detachably attached to the hub flange 36 fixed to the hub-side end portion 24a of the output shaft 24. As a result, the wheel 12 is rotationally driven one-on-one by the electric motor 14.

### EXAMPLE 2

Another example of the present invention will be described. In the following description, the portions common to the example described above are denoted by the same reference numerals and will not be described.

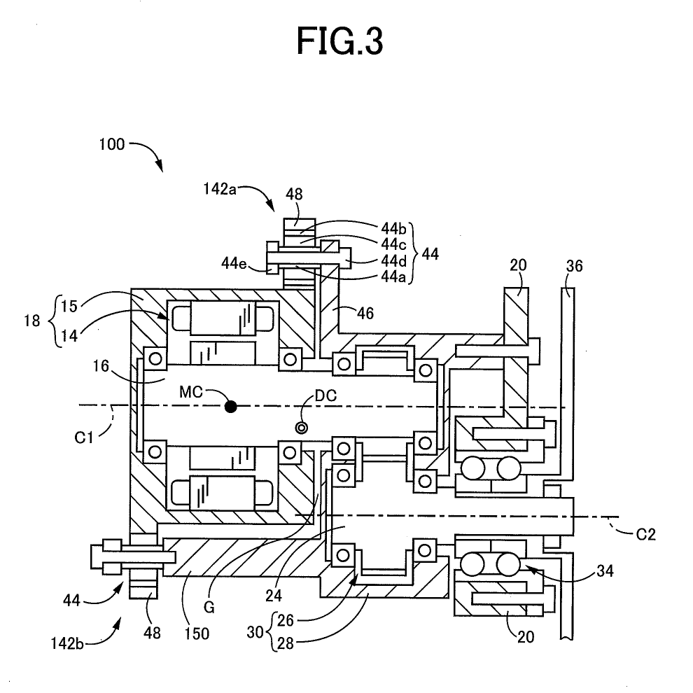

As compared to the coupling devices 42 of the vehicle in-wheel type motor drive device 10 of the example described above, coupling devices 142a, 142b of a vehicle in-wheel type motor drive device 100 of the example shown in FIG. 3 are different in positions of the elastic devices 44 relative to the motor portion 18, i.e., the motor case 15, and are the same in the other points. The difference will hereinafter be described.

In FIG. 3, a pair of the coupling devices 142a, 142b is configured such that the elastic devices 44 are located across the gravity center MC of the motor portion 18 or the electric motor 14. In this example, the one coupling device 142a of the paired coupling devices 142a, 142b includes, as in the example described above, the bracket 46 disposed in a projecting manner from the end portion of the reducer case 28 on the motor case 15 side toward the outer circumferential side from the first rotation center line C1, the holding cylinder 48 fixedly attached by welding etc. to the end portion of the outer circumferential surface of the motor case 15 on the reducer case 28 side, and the elastic device 44 respectively interposed between the tip portion of the bracket 46 and the holding cylinder 48.

The other coupling device 142b includes bracket 150, the holding cylinder 48, and the elastic device 44. The bracket 150 is disposed in a projecting manner from the reducer case 28, such that the bracket 150 projects from a position on the side opposite to the brackets 46 of the one coupling device 142a with respect to the first rotation center line C1 and at the end portion of the reducer case 28 on the motor case 15 side in the direction of the axis C1, and extends in parallel with the first rotation center line C1 until reaching the end portion of the motor case 15 on the side opposite to the reducer case 28 in the direction of the axis C1. The holding cylinder 48 is fixedly attached by welding etc. to the end portion of the outer circumferential surface of the motor case 15 on the side opposite to the reducer case 28 in the direction of the axis C1. The elastic device 44 is interposed between a tip portion of a bracket 150 and the holding cylinder 48.

According to the vehicle in-wheel type motor drive device 100 of this example, the elastic member 44c of the one coupling device 142a and the elastic member 44c of the other coupling device 142b are disposed to symmetrically act about the gravity center MC of the motor portion 18, i.e., the electric motor 14. As a result, the change in the drive force of the electric motor 14 and the vibration associated with the up-and-down motion of the vehicle in-wheel type motor drive device 100 are more effectively absorbed by the elastic members 44c of the coupling devices 142a, 142b disposed at multiple positions.

### EXAMPLE 3

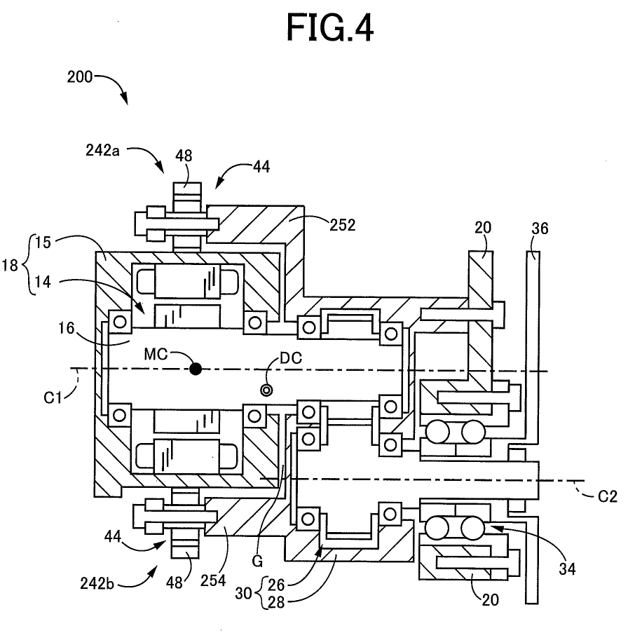

As compared to the coupling devices 42 of the vehicle in-wheel type motor drive device 10 of the example described above, coupling devices 242a, 242b of a vehicle in-wheel type motor drive device 200 of the example shown in FIG. 4 are different in positions of the elastic devices 44 relative to the motor portion 18 or the motor case 15, and are the same in the other points. The difference will hereinafter be described.

In FIG. 4, a pair of the coupling devices 242a, 242b is configured such that the elastic devices 44 are located across the gravity center MC of the motor portion 18 or the electric motor 14. In this example, the one coupling device 242a of the paired coupling devices 242a, 242b includes brackets 252 disposed in a projecting manner to extend from the end portion of the reducer case 28 on the motor case 15 side toward the outer circumferential side from the first rotation center line C1 and in parallel with the first rotation center line C1 until reaching an intermediate position of the motor case 15 in a direction parallel to the first rotation center line C1, the holding cylinder 48 fixedly attached by welding etc. to the intermediate position in the direction parallel to the first rotation center line C1 on the outer circumferential surface of the motor case 15, and the elastic device 44 respectively interposed between a tip portion of the bracket 64 and the holding cylinder 48.

The other coupling device 242b includes bracket 254 disposed in a projecting manner from a position on the side opposite to the bracket 252 of the one coupling device 242a with respect to the first rotation center line C1 in the end portion of the reducer case 28 on the motor case 15 side in parallel with the first rotation center line C1 until reaching the intermediate position of the motor case 15 in the direction parallel to the first rotation center line C1, the holding cylinder 48 fixedly attached by welding etc. to the intermediate position in the direction parallel to the first rotation center line C1 on the outer circumferential surface of the motor case 15, and the elastic device 44 respectively interposed between a tip portion of the bracket 254 and the holding cylinder 48.

According to the vehicle in-wheel type motor drive device 200 of this example, the elastic member 44c of the one coupling device 242a and the elastic member 44c of the other coupling device 242b are disposed to symmetrically act about the gravity center MC of the motor portion 18 or the electric motor 14. As a result, the change in the drive force of the electric motor 14 and the vibration associated with the up-and-down motion of the vehicle in-wheel type motor drive device 200 are more effectively absorbed by the elastic members 44c of the coupling devices 242a, 242b disposed at multiple positions.

Although the examples of the present invention have been described with reference to the drawings, the present invention is also applied in other forms.

For example, in Example 1 described above, the elastic devices 44 of the coupling devices 42 are arranged at three positions at equal angular intervals around the first rotation center line C1 of the electric motor 14; however, the elastic devices 44 may be arranged at two positions or four positions etc. In Examples 2 and 3, the elastic devices 44 of the coupling devices 142a, 142b and 242a, 242b are disposed at two positions at equal angular intervals around the first rotation center line C1 of the electric motor 14; however, the elastic devices may be disposed at three or more positions. In short, the elastic devices may be disposed at equal angular intervals around the first rotation center line C1 to perform a symmetrical and uniform elastic action about the first rotation center line C1 of the electric motor 14.

Although the reducer 26 in the examples is a two axes gear reducer with single-speed reduction, the reducer may be a three-shaft gear reducer with two-speed reduction or a reducer of another type.

The above description is merely an embodiment, and the present invention can be implemented in variously modified and improved forms based on the knowledge of those skilled in the art without departing from the spirit thereof although not exemplarily illustrated one by one.

### REFERENCE SIGNS LIST

10, 100, 200: In-wheel type motor drive device

12: Wheel

14: Electric motor

14a: Stator

14b: Rotor

14c: Motor bearing

15: Motor case

16: Motor rotating shaft

16a: Reducer-side end portion

18: Motor portion

20: Wheel hub (Non-rotating member)

22: Fastening bolt

24: Output shaft

24a: Hub-side end portion

26: Reducer

26a: Input-side bearing

26b: Small-diameter reduction gear

26c: Output-side bearing

26d: Large-diameter reduction gear

28: Reducer case

30: Reducer portion

34: Hub bearing

34a: Inner ring

34b: Outer ring

34c: Spherical rolling element

36: Hub flange

38: Nut

40: Bolt

42, 142a, 142b, 242a, 242b: Coupling device

44: Elastic device

44a: Small-diameter cylindrical body

44b: Large-diameter cylindrical body

44c: Elastic member

44d: Fastening bolt

44e: Nut

46: Bracket

48: Holding cylinder

150: Bracket

252: Bracket

254: Bracket

C1: First rotation center line

C2: Second rotation center line

G: Predetermined gap

MC: Gravity center of a motor portion

DC: Gravity center of an in-wheel type motor drive device

What is claimed is:

1. A vehicle in-wheel type motor drive device comprising: a motor portion configured to include an electric motor; and a reducer portion configured to be fixed to a non-rotating member rotatably supporting a wheel and to include a reducer reducing a speed of rotation input from a motor rotating shaft of the electric motor to output the rotation from an output shaft concentric with the wheel, the vehicle in-wheel type motor drive device rotationally driving the wheel by the output of the reducer portion, wherein
an end portion of the motor rotating shaft on the reducer portion side is rotatably supported in a cantilever manner by the reducer portion, and wherein
a coupling device coupling the motor portion via an elastic member to the reducer portion is disposed between the motor portion and the reducer portion.

2. The vehicle in-wheel type motor drive device according to claim 1, wherein
the reducer portion includes a reducer case housing the reducer and fixed to the non-rotating member, wherein
the motor portion includes a motor case housing the electric motor in a state of being separated from the reducer case, and wherein
the coupling device is disposed between the motor case and the reducer case.

3. The vehicle in-wheel type motor drive device according to claim 1, wherein
the coupling device is disposed at a plurality of positions around the motor rotation axis.

4. The vehicle in-wheel type motor drive device according to claim 3, wherein
the coupling devices disposed at the plurality of positions include respective elastic members, and the elastic members are disposed to symmetrically act about a rotation center line or a gravity center of the electric motor.

5. The vehicle in-wheel type motor drive device according to claim 1, wherein
the coupling device absorbs a swing of the motor portion with respect to the reducer portion and limits a relative rotation of the motor portion to the reducer portion around the motor rotating shaft.

6. The vehicle in-wheel type motor drive device according to claim 1, wherein
the motor portion is supported by the reducer portion via the motor rotating shaft.

7. The vehicle in-wheel type motor drive device according to claim 1, wherein
the reducer is a two axes gear reducer in which a small-diameter reduction gear disposed on the motor rotating shaft serving as an input shaft and a large-diameter reduction gear disposed on the output shaft are meshed with each other.

8. The vehicle in-wheel type motor drive device according to claim 1, wherein
a hub-side end portion of the output shaft is rotatably supported via a hub bearing by the non-rotating member, and wherein
the wheel is detachably attached to a hub flange fixed to a tip of the output shaft.
